(19) United States
(12) Patent Application Publication
(10) Pub. No.: US 2022/0194458 A1
(43) Pub. Date: Jun. 23, 2022

(54) TRANSPORTATION APPARATUS

(71) Applicant: ALL DAY DESIGNS LTD, Glasgow (GB)

(72) Inventor: Amanda Day, Glasgow (GB)

(73) Assignee: ALL DAY DESIGNS LTD, Glasgow (GB)

(21) Appl. No.: 17/604,024

(22) PCT Filed: Apr. 15, 2020
(86) PCT No.: PCT/EP2020/060556

§ 371 Date: Oct. 15, 2021

(30) Foreign Application Priority Data
Apr. 15, 2019 (GB) 1905308.1

(51) Int. Cl. B62B 9/12; B62M 1/38; B62M 9/00; B62B 7/04; B62K 19/30; B62B 9/00

(52) U.S. Cl. CPC B62B 9/12; B62M 1/38; B62B 9/00; B62B 7/042; B62K 19/30; B62M 9/00

(57) ABSTRACT

A transportation apparatus (1) comprises a frame (12) having an engagement portion or receiving portion (14) adapted to receive one or more occupant support devices (16); and drive means (20) configured to enable an occupant of the transportation apparatus (1) to power, drive and/or steer the transportation apparatus (1). The drive means (20) has a first configuration or position and a second configuration or position, wherein the drive means (20) is closer to the engagement portion or receiving portion (14) of the frame (12) in the second configuration or position than in the first configuration or position.

### FIELD

Embodiments described herein relate generally to a transportation apparatus and associated methods; and in particular, but not exclusively, to a child transportation apparatus reconfigurable between at least two modes of operation.

### BACKGROUND

Strollers, perambulators (prams) or pushchairs are used to transport children who may not be able to or may not wish to walk or otherwise propel themselves on an entire journey or trip. Children, particularly toddlers or young children, may not be as capable or willing to walk for as far or as long as an accompanying adult. Accordingly, strollers, perambulators (prams) or pushchairs provide the ability for the accompanying adult to push the child along for all or parts of the journey or trip as appropriate.

The child may become restless or lack stimulation when pushed the entire time, so the child may not wish to be pushed along sitting, lying or slouching in a stroller, perambulator (pram) or pushchair for the entire time. The child may wish to be active, such as to get out of the stroller, perambulator (pram) or pushchair, perhaps walking for at least a part of the journey or trip.
tiresome for the child and/or the accompanying adult, another form of child transportation may be desirable for the child and/or the accompanying adult. For example, the child and or the accompanying adult may wish the child to use a scooter, tricycle, bicycle or the like. The scooter, tricycle, bicycle or the like may allow or assist in transporting the child at a pace conforming or better conforming to a desired pace of the accompanying adult, such as when compared to
tricycle, bicycle or the like may allow or assist the child to be stimulated or entertained. For example, the child may consider scootering or cycling to be more fun than walking. Scootering and cycling may provide alternative transport to walking or sitting in a stroller or pushchair.

Typically at the start of a journey or trip a child and/or the accompanying adult may have a free choice whether to complete the journey or trip by walking and/or pushing in a pushchair, stroller or perambulator (pram); or to complete the journey by walking and/or scootering or cycling or the like. Accordingly, either a pushchair, stroller or perambulator (pram) can be taken for the journey or trip; or a scooter, tricycle, bicycle or the like can be taken for the journey or trip.

It may be an object of at least one or more embodiments or features of the present disclosure to address one or more problems or disadvantages associated with the prior art.

### SUMMARY

This disclosure provides a transportation device which can convert between a number of different modes. For example, in one mode, the device can be a stroller (or some sort of pedal powered device.

Thus, according to a first aspect there is provided a transportation apparatus comprising:

a frame, the frame having an engagement portion or receiving portion adapted to receive one or more occupant support devices; and

drive means configured to enable an occupant of the transportation apparatus to power, drive and/or steer the transportation apparatus,

wherein the drive means has a first configuration or position and a second configuration or position, wherein the drive means is closer to the engagement portion or receiving portion of the frame in the second configuration or position than in the first configuration or position.

The frame may comprise or may be a chassis.

not necessarily be limited to providing a releasable connection, but may also include or provide a permanent and/or one-piece connection between the frame and one or more occupant support devices.

The engagement portion or receiving portion may be adapted to releasably receive one or more occupant support devices, e.g., a seat. In such instance the engagement portion or receiving portion may comprise or may define a releasable connection between the frame and one or more occupant support devices. One or more occupant support devices may be detachable from the engagement portion or receiving portion, and/or from the frame. By such provision, the apparatus may be arranged to receive a number of different occupant support devices which may be selected depending on the age and/or size of the child, whether the child is asleep or awake, etc. The engagement portion or receiving portion may comprise a region of the frame to which one or more occupant support devices is attachable. In such instance, a region of the frame may define the engagement portion or receiving portion. Thus the engagement portion can be the frame or it can be on any part of the frame and it may comprise a portion suitable to receive one or more occupant support devices. The one or more occupant support device may then be releasably fixed thereto by any push, interference fit mechanism, screws/bolts, loop-hook fastenings, or the like. One or more occupant support devices may have features complementary to features of the engagement portion or receiving portion. By such provision, the engagement portion or receiving portion may be adapted to interact with and/or connect to one or more occupant support devices.

The engagement portion or receiving portion may be adapted to permanently receive one or more occupant support devices. In such instance the engagement portion or receiving portion may comprise or may define a permanent connection between the frame and the one or more occupant support devices. The one or more occupant support devices and the frame may define a unitary or one-piece structure. In such instance, the engagement portion or receiving portion may not define a separate part from the frame and/or occupant support device(s), but may form part of the frame and occupant support device(s), and/or may for part of the unitary or one-piece structure.

The frame may comprise one or more, e.g., a plurality of, engagement portions or receiving portions. Each engagement portion or receiving portion may be adapted to receive one or more occupant support devices. By such provision, the apparatus may have a number of engagement portions or receiving portions, each engagement portion or receiving portion being adapted to receive one or more of the occupant support devices. This may be advantageous as the sizes, shapes and positions of the occupant support devices being compatible with the apparatus may vary. Thus, despite the possible differences in shapes, sizes and positions between the various occupant support devices, the provision of a plurality of engagement portions or receiving portions may allow the apparatus to receive each of the occupant support devices.

Occupant support devices may be selected from, but are not limited to, a carrycot, a seat such as a car seat, a midi seat, or a stroller seat, a bicycle saddle and/or tricycle saddle, and the like. Occupant support devices may be configured to accommodate one or more occupants. For example, one or more occupant support devices may be configured to accommodate an infant, a baby, a toddler, a child or an adult.

In an embodiment, the occupant support device may be a stroller seat. The stroller seat may be permanently or reversibly attached to the engagement portion or receiving portion of the frame.

The frame may be foldable. The frame may be configured to be folded, for example for ease of storage. The frame may be foldable with an occupant support device attached to it. The frame may be configured to be folded without an occupant support device attached to it.

In use, the transportation apparatus and/or frame may be in a deployed and/or non-folded state. The first configuration or position and the second configuration or position of the drive means may be provided in the deployed and/or non-folded state. By such provision, a non-occupant user, that is, a person who pushes and/or steers the apparatus but is not located in the apparatus, may move, change or alter the drive means from the first configuration to the second configuration without the need to fold the apparatus or frame and/or without requiring removal of the/an occupant support device or occupant thereof. The drive means may be moved, changed or altered from the first configuration or position to the second configuration or position without removal of the/an occupant support device or occupant thereof.

The transportation apparatus may comprise at least one front wheel. The transportation apparatus may comprise one front wheel, which may typically be provided substantially centrally relative to a longitudinal direction of the frame. The transportation apparatus may comprise a plurality of front wheels, for example two or more front wheels. When the transportation apparatus comprises two or more front wheels, the front wheels may be connected by an axle. The transportation apparatus may comprise one or more rear wheels. The transportation apparatus may comprise one rear wheel, which may typically be provided substantially centrally relative to a longitudinal direction of the frame. The transportation apparatus may comprise a plurality of rear wheels, for example two or more rear wheels. When the transportation apparatus comprises two or more rear wheels, the rear wheels may be connected by an axle. For example, the transportation apparatus may comprise one front wheel located at or near a front end of the frame and/or apparatus and two rear wheels located at or near a rear end of the frame and/or apparatus, or vice versa. Suitable wheels for the transportation apparatus may comprise, but are not limited to, plastic wheels/tyres, rubber coated wheels/tyres, air-filled wheels/tyres, pneumatic wheels/tyres, foam-filled tyres, air wheel tyres with sealed ball bearings, omni wheels, and the like. Typically, the wheels, e.g. front wheel(s) and/or rear wheel(s) may be attached, e.g. permanently attached or removably attached, to the frame.

The drive means may comprise propelling means or power means and/or steering means.

Propelling means or power means may comprise means for propelling, powering or driving, e.g. mechanically and/or electronically propelling, powering or driving, one or more wheels.

The propelling means or power means may be configured to propel, power or drive, e.g. mechanically and/or electronically propel, power or drive, at least one front wheel, e.g. the front wheel.

The propelling means or power means may be configured to propel, power or drive, e.g. mechanically and/or electronically propel, power or drive, at least one rear wheel. In such instance, the propelling means may be connected to at least one rear wheel by a drive mechanism such as a chain, belt, pulley or the like.

The propelling means or power means may comprise levers or pedals for propelling, powering or driving, e.g. mechanically propelling, powering or driving, one or more wheels. The pedals may be directly attached to a wheel, such that the pedals are configured to drive the wheel to which they are attached. For example, the pedals may be permanently fixed to a wheel hub or wheel axle. The pedals may not move in relation to the wheel. For example, the at least one front wheel may comprise levers or pedals. The pedals may be integrated within the at least one front wheel. The pedals may be attached, for example permanently attached to the at least one front wheel. In embodiments in which the pedals are directly attached to a wheel, the wheel may be directly driven by the pedals.

One or more pedals may be attached, for example permanently or detachably attached, to a pedal support element. Each pedal may be attached to a respective pedal support element. The pedal support element(s) may be connected to the at least one front wheel and/or to the at least one rear wheel. The pedal support element(s) may be a structural element configured to connect or couple pedals to the frame of a wheel. The pedal support element(s) may be a plate, fork, bar or the like. The pedal support element may be connected to the at least one front wheel and/or to the at least one rear wheel in a stationary fashion. The pedal support element(s) may be connected to one or more wheel(s), e.g. the at least one front wheel and/or to the at least one rear wheel, and/or to the frame, in a movable fashion, for example a rotational and/or pivotal fashion. The pedal support element(s) may define a first configuration in which the pedals are further from the engagement portion or receiving portion of the frame and a second configuration in which the pedals are closer to the engagement portion or receiving portion of the frame. The pedal support element(s) may be configured to rotate about an axis, e.g. parallel to an axis of the at least one front wheel and/or the at least one rear wheel, to move from the first configuration of the drive means to the second configuration of the drive means.

The pedals and/or pedal support element(s) may be coupled to a wheel, e.g. a front and/or a rear wheel, by means of a drive coupler, such as a belt, pulley, chain, or the like. The drive coupler may be configured to transmit power from the pedals to the wheel or wheels to which the drive coupler is connected such that application of a force on the pedals may drive the wheel or wheels. In embodiments in which the pedals are attached to a pedal support element which is itself attached to a wheel, the wheel may be considered to be indirectly driven by the pedals.

The pedals may be foldable and/or may be configured to be stored, e.g. within a wheel such as the at least one front wheel. The pedals may be detachable from a respective wheel, e.g. from. the at least one front wheel. Provision of detachable and/or foldable pedals may avoid or reduce the risk of damaging the pedals and/or injuring passers-by and/or the occupant when use of the pedals is not required, thus improving safety. The pedals may comprise a deployed configuration and a stowed configuration. Each pedal may extend along a plane substantially parallel to the ground in the deployed configuration. Each pedal may be folded within a respective wheel, e.g. within a side thereof, in the stowed configuration. The pedals may comprise two modes of operation. In a first mode of operation, the pedals may be configured to move independently from an associated wheel, e.g. front wheel, and/or to move in a non-powering manner, thus providing free-wheeling action. In a second mode of operation, the pedals may be configured to move in a powering manner and/or may be locked relative to an associated wheel, e.g., at least one front wheel, for example relative to a rotation axis thereof, thus allowing powering of an associated wheel, e.g., the at least one front wheel.

The drive means may comprise a drive body member. The drive body member may take any suitable shape or form. For example, the drive body member may be a frame-like element. The drive body member may be a slider. The drive body member may be a telescopic frame. The at least one front wheel may be connected to the drive body member. The pedal support element may be connected to the drive body member. The drive body member may be coupled or connected to the frame of the transportation apparatus. One or more wheels, e.g., at least one front wheel, and/or the pedal support element and/or pedals may move relative to the frame of the transportation apparatus. In embodiments in which the drive body member is a slider, one or more wheels, e.g., at least one front wheel, may be slidably connected to the drive body member. The pedal support element may be slidably connected to the drive body member. In embodiments in which the drive body means is a telescopic frame, a wheel, e.g. the at least one front wheel, and/or the pedal support element may be fixedly connected to the drive body member and the wheel and/or pedal support element may move relative to the frame by extending (deploying) or retracting (collapsing) the telescopic frame of the drive body member.

The steering means may be configured to enable an occupant of the transportation apparatus to steer, direct or manoeuvre the apparatus. The steering means may comprise a handlebar and a column, stem or member configured to be connected to the front wheel or wheels. In use, altering the orientation of the handlebar may result in altering the orientation of one or more wheels, e.g. front wheel or wheels and/or rear wheel or wheels, thus modifying the direction of travel of the apparatus.

The steering means may be incorporated within or may be integral to the frame of the transportation apparatus. The steering means may be incorporated within or may be integral to one or more wheels, e.g. front wheel or wheels and/or rear wheel or wheels. The steering means may be incorporated within or may be integral to the drive body means.

The steering means may be detachable from the frame of the transportation apparatus. The steering means may be detachable from one or more wheels, e.g. front wheel or wheels and/or rear wheel or wheels. The steering means may be detachable from the drive body means.

The steering means may be integrated within the frame of the transportation apparatus or within the drive body means. The steering means may be foldable. The steering means may be configured to be folded when not in use, for example to be stored within the frame or the drive body means. The steering means may be configured to be folded and stored within the frame or the drive body means in the first configuration or position of the drive means. For example, the handlebar may be foldable. The column, stem or member may be foldable. The column, stem or member may be pivotally connected to the frame or the drive body means. When the drive means is in the first configuration or position, the steering means may be in a stowed configuration in which the steering means is stored or located inside the frame or drive body means. When the drive means is in the second configuration or position, the steering means may be in a deployed configuration in which the steering means is connected to one or more wheels, e.g. front wheel or wheels and/or rear wheel or wheels. The steering means may be configured to pass from the stowed configuration to the deployed configuration by pulling the steering means out of the frame and/or drive body means, rotating the steering means until reaching a position in which the steering means is engaged with one or more wheels, e.g. front wheel or wheels and/or rear wheel or wheels, and locking the steering means in place. Locking the steering means to the wheel may be achieved by any suitable locking mechanism, such as a clutch, pin, fixing or the like. When the steering means is in the stowed configuration the handlebar may be folded. When the steering means is in the deployed configuration the handlebar may be extended. The handlebar may be configured to pass from the folded to the extended state by turning the handlebar and/or by moving the handlebar elements. The handlebar elements may be locked in the extended state in the deployed configuration of the steering means. Locking the handlebar in the extended state may be achieved by any suitable locking mechanism, such as a clutch, pin, fixing or the like.

The steering means may be telescopic. The steering means may be configured to be retracted, stowed or collapsed in a first configuration or position of the drive means. The steering means may be configured to be expanded, deployed or extended in a second configuration or position of the drive means.

Advantageously, providing steering means which is foldable, telescopic and/or detachable from the frame or the drive body means when the drive means is in its first configuration or position may increase the comfort of the occupant of the transportation apparatus and may facilitate the loading and unloading operations of the transportation apparatus. Moreover, providing a steering means foldable, telescopic and/or detachable from the frame or the drive body means when the drive means is in its first configuration or position does not enable an occupant of the transportation apparatus to steer the transportation apparatus. This is desirable when the transportation apparatus is in the pram or stroller mode, for example for safety and/or aesthetic reasons.

The steering means may be configured to be deployed or extended in the second configuration. The steering member may be configured to be engaged with and/or attached to one or more wheels, e.g. at least one front wheel and/or rear wheel or wheels in the second configuration. The steering member may enable steering of the transportation apparatus when the steering member is engaged with and/or locked relative to one or more wheels, e.g. at least one front wheel and/or rear wheel or wheels. Engaging or locking the steering means to at least one wheel may be achieved by any suitable locking mechanism, such as a clutch, pin, fixing or the like.

The steering means may not enable steering of the transportation apparatus when the steering means is not engaged with and/or locked relative to one or more wheels, e.g at least one front wheel and/or rear wheel or wheels. Advantageously, disabling engagement and/or the lock of the steering member relative to the at least one front wheel may increase the safety of the transportation apparatus and facilitate the manoeuvrability of the transportation apparatus by a non-occupant. The steering means may be releasably engageable with the at least one front wheel to enable steering of the transportation apparatus.

The frame may comprise a holding member, for example a handle or handlebar for a non-occupant of the child transportation apparatus. In use, the non-occupant handle/handlebar may enable the frame to be propelled and/or steered by a non-occupant of the transportation apparatus. The non-occupant handlebar may be located at, behind, and/or near a rear end of the frame. The non-occupant handlebar may be extendable. For example, the non-occupant handlebar may be telescopic and/or removable. This is beneficial to adapt the height of the handlebar to the height of the non-occupant. For example, a tall non-occupant may find more comfortable to push the apparatus with the non-occupant handle in an extended configuration, to prevent having to bend in order to reach the non-occupant handlebar.

The transportation apparatus, e.g. the drive means or steering means, may comprise a brake adapted to restrict movement of the front wheel/wheels. The frame may comprise or may be equipped with a brake adapted to restrict movement of an associated wheel, e.g. of the front wheel or wheels. The drive means, steering means and/or the frame may comprise a brake adapted to restrict movement of the rear wheel/wheels. In use, when the brake is actuated, the movement of at least one of the front and/or rear wheels may be restricted. This is beneficial, for example when going downhill, if an occupant or a non-occupant user wants to ensure that the apparatus moves in a slow and controlled fashion and/or to ensure that the apparatus does not move at all. When the brake is not actuated the wheels may be configured to rotate freely.

In the first configuration or position of the drive means the apparatus may take the form of a stroller or pram type device with the drive means being configured to be inoperable by, out of reach for or inaccessible to an occupant located at an occupant support device, such as a stroller seat. In this way, an occupant of the apparatus may not be able to power, drive or steer the apparatus. In the second configuration the apparatus may take the form of a tricycle, for example, and in this configuration the drive means may be configured to be operable by, within reach for or accessible to an occupant to drive the transportation apparatus. In such an example the first configuration or position of the drive means may be suitable for use of the apparatus as a stroller or pram and the second configuration or position of the drive means may be suitable for use of the apparatus as a tricycle or the like.

The drive means may comprise any suitable means, such as a switching mechanism, for moving from the first configuration or position to the second configuration or position.

For example, in embodiments in which the drive means comprises a pedal support element to which the pedals are attached, the pedal support element may be pivotally connected to the at least one front wheel. In the first configuration, the portion of the pedal support element to which the pedals are attached may be further away from the engagement portion of the frame or a seat than in the second configuration. The drive means may move from the first configuration to the second configuration by rotating or turning the pedal support element about a pivot point such that the pedals move from a first position in which the pedals are further away from the engagement portion to a second position in which the pedals are closer to the engagement portion. For example, the pedal support element may be connected to the at least one front wheel or the frame by means of a hinge or a barrel. The pedal support element may pivot about the connection point between the pedal support element and the at least one wheel or the frame.

In embodiments in which the drive means comprises a drive body member, an associated wheel, e.g. at least one front wheel(s) and/or rear wheel or wheels and/or the pedals may be located further from the engagement portion of the frame in the first configuration or first position and the associated wheel(s) and/or the pedals may be located closer to the engagement portion of the frame or a seat in the second configuration or second position. In embodiments in which the drive body member is a slider, the drive means may move from the first configuration to the second configuration by sliding the associated wheel(s) and/or the pedals from a first position on the drive body member to a second position on the drive body member. In embodiments in which the drive body member comprises a telescopic frame, the drive means may move from the first configuration to the second configuration by moving the telescopic frame to which the associated wheel(s) and/or the pedals are attached or coupled to from an extended position to a retracted position on the drive body member.

In embodiments in which the steering means is detachable, the drive means may move from the first configuration to the second configuration by attaching the pedals to the drive means.

In embodiments in which the steering means is foldable, the drive means may move from the first configuration to the second configuration by deploying, unfolding or extending the steering means such that the deployed steering means is closer from the engagement portion in the second configuration than in the first configuration.

In embodiments in which the steering means is telescopic, the drive means may move from the first configuration to the second configuration by extending the steering means such that the deployed steering means is closer from the engagement portion in the second configuration than in the first configuration.

In embodiments in which the steering means is detachable, the drive means may move from the first configuration to the second configuration by attaching the steering means to the drive means.

The drive means may be movable from the first configuration or position to the second configuration or position with an occupant support device attached to the engagement portion. The drive means may be configured to move from the first configuration or position to the second configuration or position without an occupant support device attached to the engagement portion. Beneficially, the frame may comprise a single engagement portion suitable to receive one or more occupant support devices, e.g., each of the occupant support devices. By such provision, a non-occupant user does not require to alter the engagement portion or does not require any additional tools or attachment devices to attach one of the selected occupant support devices compatible with the apparatus and/or frame. Advantageously, the drive means may be movable from the first configuration or position to the second configuration or position while the occupant is located on/in the occupant support device.

At least one wheel, e.g. any or all wheels, for example at least one front wheel, may be or may comprise an omni wheel. An/the omni wheel may comprise a plurality of rolling or rotating elements disposed around the circumference of the wheel. The rolling or rotating elements may be configured to turn and/or rotate in a direction and/or around an axis perpendicular to the rotational axis of the wheel. An omni wheel may enable a non-occupant of the transportation apparatus to change the direction of movement of the frame and/or transportation apparatus independently from the orientation of the at least one front wheel. For example, when a non-occupant steers the frame in a direction different of the direction of travel, the rolling portions of the wheel may rotate in a direction perpendicular to the direction of travel, thus enabling the movement of the omni wheel along the direction of rotation of the rolling elements. Beneficially, an omni wheel may allow the apparatus to turn and/or to be manoeuvred with reduced effort without the need to change the orientation of the omni wheel. When the frame is in the second configuration and comprises a steering member engaged with and/or attached to the at least one front wheel, the orientation of the at least one front wheel, e.g., omni wheel, may be determined by a position of the steering member. Typically, when an occupant controls or handles the steering member, a non-occupant may not be able to change the direction of travel. This may cause damage to nearby objects and/or of injury to passers-by, to the occupant or to the non-occupant. Use of an omni wheel may permit a non-occupant to override the direction of travel when an occupant, e.g. a child, steers and/or powers the apparatus, e.g. at least one front wheel thereof, thus enabling a non-occupant to change the direction of movement of the apparatus without the need to alter the orientation of the wheel. Advantageously, an omni wheel that enables movement in a direction other than the direction of rotation of the wheel may enhance the safety of the apparatus comprising the omni wheel by eliminating the need of the wheel to change orientation upon steering, thus preventing or reducing the risk of damage to nearby objects and/or of injury to passers-by, to the occupant or to the non-occupant.

The transportation apparatus may be a child transportation apparatus.

It should be understood that the features defined above in accordance with any aspect of the present disclosure or below in accordance with any specific embodiment may be utilised, either alone or in combination with any other defined feature, in any other aspect of the disclosure.

### BRIEF DESCRIPTION OF THE FIGURES

FIG. 1: Side view of a transportation apparatus according to an embodiment in which the drive means is configured to indirectly drive the front wheel. The pedals are attached to a pedal support element that is pivotally mounted on the front wheel of the apparatus. The apparatus is shown in a first configuration (a) and in a second configuration (b).

FIG. 2: Side view of a transportation apparatus according to an embodiment in which the drive means is configured to indirectly drive the rear wheels. The pedals are attached to a pedal support element that is pivotally mounted on the front wheel of the apparatus. The apparatus is shown in a first configuration (a) and in a second configuration (b).

FIG. 3: Side view of a transportation apparatus according to an embodiment in which the drive means is configured to indirectly drive the front wheel. The pedals are attached to a pedal support element. Both the front wheel and the pedal support element are connected to a drive body member along which they can slide or extend between two positions. The apparatus is shown in a first configuration (a) and in a second configuration (b).

FIG. 4: Side view of a transportation apparatus according to an embodiment in which the drive means is configured to directly drive the front wheel and the pedals are attached directly to the front wheel of the apparatus (a). Transportation apparatus according to a similar embodiment to FIG. 3, in which the drive means is configured to indirectly drive the front wheel (b).

FIG. 5: Side view of a transportation apparatus according to an embodiment in which the pedals and/or the steering means are detachable from the drive means.

FIG. 6: Side view of a transportation apparatus according to an embodiment in which the drive means comprises a telescopic steering means. The apparatus is shown in a first configuration (a) and in a second configuration (b).

FIG. 7: Side view of a transportation apparatus according to an embodiment in which the drive means comprises a foldable steering means. The apparatus is shown in a first configuration (a), in an intermediate position between the first and the second configurations (b) and in a second configuration (c).

### DETAILED DESCRIPTION

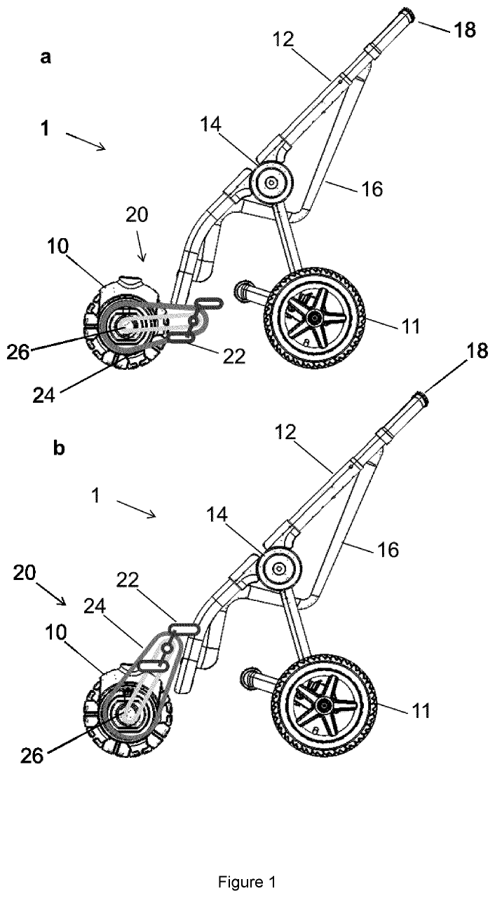

A transportation apparatus 1 is shown in FIG. 1 in a first configuration of the drive means (a) and in a second configuration of the drive means (b).

The apparatus 1 comprises a frame 12 having an engagement portion 14 to which an occupant support device (e.g. a seat) 16 is attached. The frame 12 comprises a handlebar as holding member 18 for a non-occupant to steer and push the transportation apparatus 1. A rear wheel (or pair of rear wheels) 11 is attached to the frame and a front wheel 10 is also coupled to the frame, although it is only shown schematically because the coupling arrangement to the frame may vary in alternative embodiments.

The apparatus comprises a drive means 20 which comprises a propelling means and a steering means (not shown). The propelling means comprises pedals 22, which are coupled to front wheel 10, by means of drive coupler 24. The drive coupler may be a belt, pulley, chain, or the like. The power applied to pedals 22 by an occupant of the apparatus is transmitted to the wheel 10 by means of the drive coupler 24.

Pedals 22 are attached or connected to a pedal support element 26, which may be any suitable element such as a plate, fork, bar or the like. Pedal support element 26 is connected to the frame of the wheel 10 about a pivot point which enables pedal support element 26 to rotate or move about said pivot point such that in the first configuration of the drive means 20 (shown in FIG. 1a) pedals 22 are lower or further from the engagement portion 14 than in the second configuration of the drive means 20 (shown in FIG. 1b), in which pedals 22 are closer to the engagement portion and are configured to be accessible to an occupant located in the occupant support device 16.

In order to pass from the first configuration to the second configuration a user, for example a non-occupant of the transportation apparatus, can rotate pedal support element 26 about the pivot point such that pedals 22 move from the position shown in FIG. 1a, in which pedals 22 are further away from the engagement portion and configured to be inaccessible to an occupant of the apparatus, to the position shown in FIG. 1b, in which pedals 22 are closer to the engagement portion 14 and configured to be accessible to an occupant of the apparatus.

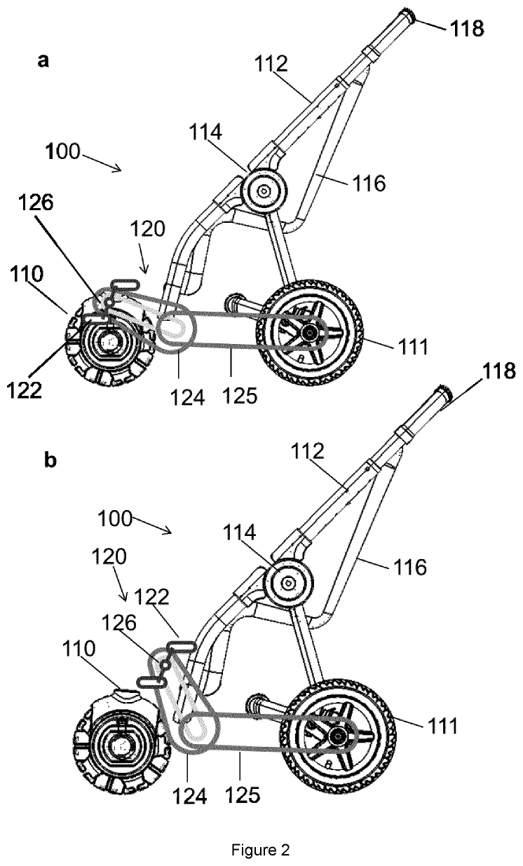

A transportation apparatus 100 is shown in FIG. 2 in a first configuration of the drive means (a) and in a second configuration of the drive means (b).

The apparatus 100 comprises a frame 112 having an engagement portion 114 to which an occupant support device (eg. a seat) 116 is attached. The frame 112 comprises a handlebar as holding member 118 for a non-occupant to steer and push the transportation apparatus 100. A rear wheel (or pair of rear wheels) 111 is attached to the frame and a front wheel 110 is also coupled to the frame, although it is only shown schematically because the coupling arrangement to the frame may vary in alternative embodiments.

The apparatus comprises a drive means 120 which comprises a propelling means and a steering means (not shown). The propelling means comprises pedals 122, which are coupled to front wheel 110, by means of drive coupler 124, and to the rear wheels by means of drive coupler 125. Drive couplers 124 and 125 may be a belt, pulley, chain, or the like. The power applied to pedals 122 by an occupant of the apparatus is transmitted to the rear wheel(s) 111 by means of the drive couplers 124, 125. Pedals 122 are attached or connected to a pedal support element 126, which may be any suitable element such as a plate, fork, bar or the like. Pedal support element 126 is connected to the frame 112 of the apparatus 100 about a pivot point which enables pedal support element 126 to rotate or move about said pivot point such that in the first configuration of the drive means 120 (shown in FIG. 2a) pedals 122 are lower or further from the engagement portion 114 than in the second configuration of the drive means 120 (shown in FIG. 2b), in which pedals 122 are closer to the engagement portion 114 and are configured to be accessible to an occupant located in the occupant support device 116.

In order to change from the first configuration to the second configuration, a user, for example a non-occupant of the transportation apparatus, can rotate pedal support element 126 about the pivot point such that pedals 122 move from the position shown in FIG. 2a, in which pedals 122 are further away from the engagement portion and configured to be inaccessible to an occupant of the apparatus, to the position shown in FIG. 2b, in which pedals 122 are closer to the engagement portion and configured to be accessible to an occupant of the apparatus.

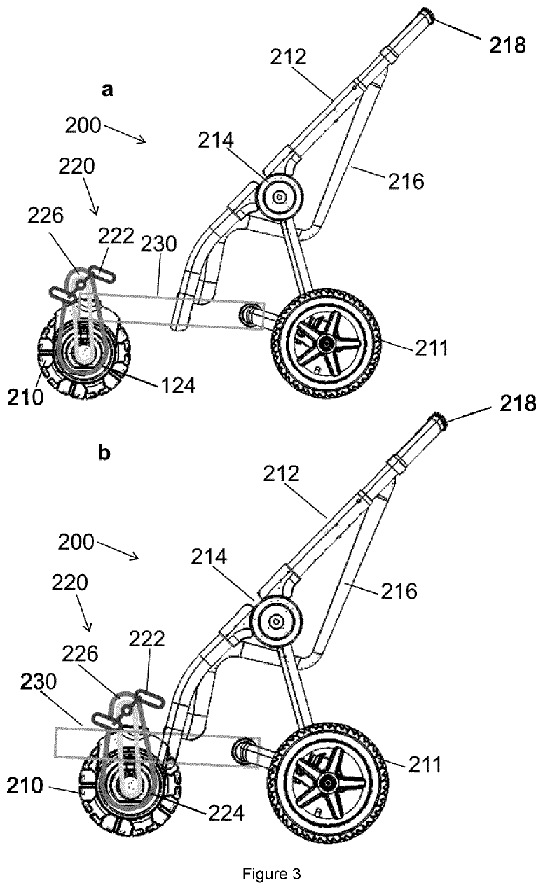

A transportation apparatus 200 is shown in FIG. 3 in a first configuration of the drive means (a) and in a second configuration of the drive means (b).

The apparatus 200 comprises a frame 212 having an engagement portion 214 to which an occupant support device (e.g. a seat) 216 is attached. The frame 212 comprises a handlebar as holding member 218 for a non-occupant to steer and push the transportation apparatus 200. A rear wheel (or pair of rear wheels) 211 is attached to the frame and a front wheel 210 is also coupled to the frame, although it is only shown schematically because the coupling arrangement to the frame may vary in alternative embodiments.

The apparatus comprises a drive means 220 which comprises a propelling means and a steering means (not shown). The propelling means comprises pedals 222, which are coupled to front wheel 210, by means of drive coupler 224. Drive coupler 224 may be a belt, pulley, chain, or the like. The power applied to pedals 222 by an occupant of the apparatus is transmitted to the front wheel 210 by means of the drive coupler 224.

Pedals 222 are attached or connected to a pedal support element 226, which may be any suitable element such as a plate, fork, bar or the like. Pedal support element 226 is connected to the frame 212 of front wheel 210 and to a drive body member 230 such that in the first configuration of the drive means 220 (shown in FIG. 3a) pedals 222 and front wheel 210 are further from the engagement portion 114 than in the second configuration of the drive means 220 (shown in FIG. 3b), in which pedals 222 are closer to the engagement portion 214 and are configured to be accessible to an occupant located in the occupant support device 216.

The drive body member 230 may be of any suitable construction. For example, it may be a frame element, such as a slider, that enables the pedal support element 226 to slide or move about the frame element. Alternatively, the drive body member 230 may comprise a telescopic frame. The front wheel 210 and/or the pedal support element 226 may be attached to a portion of the telescopic frame that may be extended or moved away from a base of the telescopic frame, thus allowing front wheel 210 and/or the pedal support element 226 to move between a position in which they are further or at a greater distance from the engagement portion 214 of the frame and a position in which they are closer from the engagement portion 214 of the frame.

In order to pass from the first configuration to the second configuration a user, for example a non-occupant of the transportation apparatus, may move pedal support element 226 and/or wheel 210 about drive body member 230 (when the drive body member is a slider) or retract the frame of the drive body member to which the front wheel 210 and/or the pedal support element 226 is attached, such that pedals 222 move from the position shown in FIG. 3a, in which pedals 222 are further away from the engagement portion and configured to be inaccessible to an occupant of the apparatus, to the position shown in FIG. 2b, in which pedals 122 are closer to the engagement portion and configured to be accessible to an occupant of the apparatus.

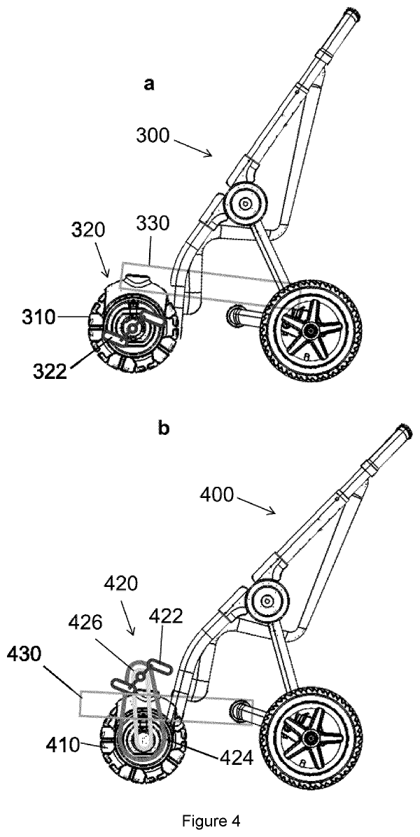

A transportation apparatus 300 is shown in FIG. 4a in a second configuration of the drive means.

The apparatus 300 comprises a drive means 320 which comprises a propelling means and a steering means (not shown). The propelling means comprises pedals 322, which are coupled directly to the front wheel 310. The power applied to pedals 322 by an occupant of the apparatus is transmitted directly to the front wheel 310.

A transportation apparatus 400 is shown in FIG. 4b in the second configuration of the drive means. Apparatus 400 corresponds to apparatus 200 shown in FIG. 3 and it is shown in this figure to highlight the difference between indirect driving of the front wheels (FIG. 4b) and direct driving of the front wheel (FIG. 4a).

The drive body member 330, 430 may be of any suitable construction, as explained above in respect of apparatus 200.

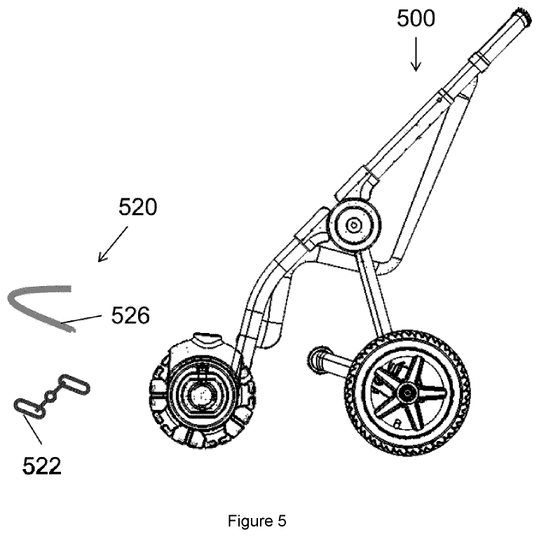

A transportation apparatus 500 is shown in FIG. 5 in the first configuration of the drive means 520. Drive means 520 comprises steering means (for example handlebar 526 and power means, which comprises pedals 522. Pedals 522 and/or handlebar 526 are detachable from the drive means 520 in this embodiment. In the first configuration, the pedals 522 and/or the handlebar 526 are detached from the drive means 520 such that they are configured to be inaccessible to an occupant of the apparatus. In the second configuration (not shown), the pedals and the steering means are attached to the drive means 520 such that they are configured to be accessible to an occupant of the apparatus 500.

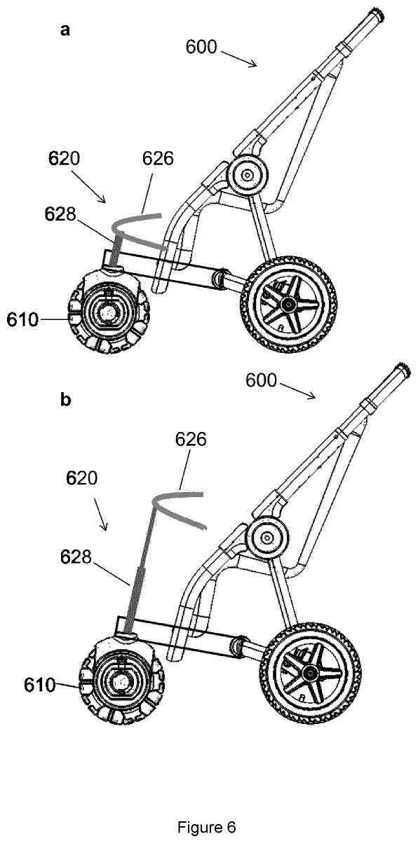

A transportation apparatus 600 is shown in FIG. 6 in a first configuration of the drive means (a) and in a second configuration of the drive means (b).

The apparatus comprises drive means 620 which comprises propelling means (not shown) and steering means. The steering means comprises a handlebar 626, which is coupled to front wheel 610, by means of a column, stem or member 628. In this embodiment column, stem or member 628 is telescopic.

In the first configuration (shown in FIG. 6a) column, stem or member 628 is in a retracted configuration such that, in use, the steering means is not accessible to an occupant of the apparatus. In the second configuration the column, stem or member 628 is extended or deployed such that, in use, the steering means is accessible to an occupant of the apparatus.

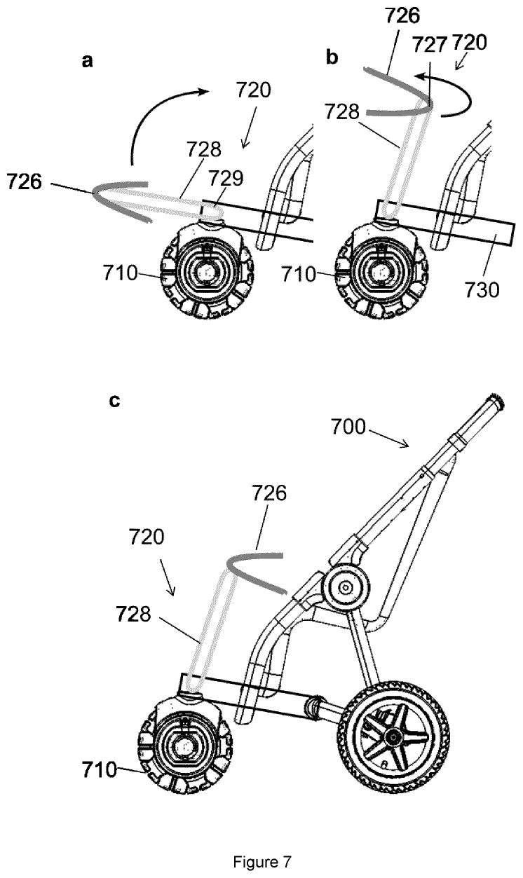

FIG. 7 shows an alternative embodiment of the steering means. In this embodiment, apparatus 700 comprises a foldable steering means. The steering means may be stored inside the frame of the apparatus and/or a drive body means 730 of the apparatus, for example in a folded state.

FIG. 7a shows the steering means in a position in which it is being pulled out of the drive body means 730 where it is stowed when not in use. The steering means comprises a handlebar 726 and a column, stem or member 728.

Handlebar 726 is pivotally connected to column, stem or member 728 about a pivot point 727, which allows the handlebar 726 to rotate. For example, in a stowed configuration the ends of handlebar 726 may point away from an engagement portion of the frame of the apparatus 700, such that the handlebar can be more easily stored. In a deployed configuration, the ends of handlebar 726 may point towards the engagement portion of the frame of the apparatus 700, such that an occupant of the apparatus may, in use, hold on to the ends of the handlebar and steer the apparatus.

Handlebar 726 may be flexible, for example foldable to allow the handlebar 726 to be folded such that it fits inside a portion of the frame of the apparatus 700 and/or a drive body means 730. Alternatively, or additionally, handlebar 726 may comprise hinges or any other suitable mechanism to allow the handlebar 726 to pass from a stowed configuration to a deployed configuration.

Column, stem or member 728 is connected to front wheel 710 about a pivot point 729, such that column, stem or member 728 can rotate, or move about the pivot point between the first configuration (shown in FIG. 7a) and the second configuration (shown in FIGS. 7b and 7c).

When the apparatus 700 is in the first configuration, the longitudinal axis of the column, stem or member 728 is aligned with the longitudinal axis of the portion of the frame of the apparatus 700 or drive body means 730 in which the steering means is stored. When the apparatus 700 is in the second configuration, the longitudinal axis of the column, stem or member 728 is disposed at an angle, for example about 90 degrees, from the longitudinal axis of the portion of the frame of the apparatus 700 and/or the drive body member in which the steering means is configured to be stored in the first configuration.

In order to change from the first to the second configuration, a user, for example a non-occupant of the apparatus 700 pulls the steering means out of the portion of the frame of the apparatus and/or drive body member 730 in which the steering means is stored and rotates the column, stem or member 728 about pivot point 729 (e.g. a hinge) (see FIG. 7a). Once the column stem or member 728 is in this position, the handlebar 726 is deployed, for example by rotating the handlebar about pivot point 727 (see FIG. 7b) such that the ends of the handlebar point towards the engagement portion of the apparatus (see FIG. 7c).

The steering means of any one of the described embodiments 500 to 700 may be combined with the power means of any one of the described embodiments 1 to 500.

Beneficially, embodiments of the apparatus, such as those shown in FIGS. 1 to 7, allow the apparatus to pass from a first mode of operation (e.g. a stroller or pram mode) to a second mode of operation (e.g. a trike mode), without the need to move or remove the occupant support device (e.g. seat) or an occupant thereof.

1-18. (canceled)

19. A transportation apparatus comprising:
a frame, the frame having an engagement portion or receiving portion adapted to receive one or more occupant support devices; and
drive means configured to enable an occupant of the transportation apparatus to power, drive and/or steer the transportation apparatus,
wherein the drive means has a first configuration or position and a second configuration or position, wherein the drive means is closer to the engagement portion or receiving portion of the frame in the second configuration or position than in the first configuration or position.

20. The transportation apparatus of claim 19, wherein the engagement portion or receiving portion is adapted to releasably receive one or more occupant support devices selected from the group comprising a carrycot, a car seat, a midi seat, a stroller seat, a bicycle saddle and/or tricycle saddle.

21. The transportation apparatus of claim 19, wherein the drive means is configured to be moved, changed or altered from the first configuration or position to the second configuration or position without removal of the/an occupant support device or occupant thereof.

22. The transportation apparatus of claim 19, wherein the drive means comprises propelling means or power means and/or steering means.

23. The transportation apparatus of claim 22, wherein the propelling means or power means comprises means for propelling, powering or driving one or more wheels.

24. The transportation apparatus of claim 23, wherein the propelling means or power means is configured to propel, power or drive at least one front wheel.

25. The transportation apparatus of claim 23, wherein the propelling means or power means is configured to propel, power or drive at least one rear wheel.

26. The transportation apparatus of claim 23, wherein the propelling means or power means is connected to at least one front wheel or to at least one rear wheel by a drive mechanism.

27. The transportation apparatus of claim 23, wherein the propelling means or power means comprise levers or pedals for propelling, powering or driving one or more wheels.

28. The transportation apparatus of claim 27, wherein one or more pedals are attached to a pedal support element.

29. The transportation apparatus of claim 28, wherein the pedal support element is movably connected to the frame and/or to one or more wheel(s).

30. The transportation apparatus of claim 29, wherein the pedal support element is pivotally connected to the frame and/or to one or more wheels.

31. The transportation apparatus of claim 27, wherein the pedals and/or pedal support element are coupled to one or more wheel by means of a drive coupler.

32. The transportation apparatus of claim 31, wherein the drive coupler comprises a belt, a pulley, and/or a chain.

33. The transportation apparatus of claim 19, wherein the drive means comprises a drive body member, wherein one or more wheels and/or one or more pedal support elements are connected to the drive body member.

34. The transportation apparatus of claim 33, wherein the drive body member comprises a slider, and wherein one or more wheel(s) and/or pedal support element(s) are slidably connected to the drive body member.

35. The transportation apparatus of claim 33, wherein the drive body member comprises a telescopic frame, and wherein one or more wheel(s) and/or pedal support elements moves relative to the frame by extending or retracting the telescopic frame.

36. The transportation apparatus of claim 22, wherein the steering means is detachable, foldable, and/or telescopic.
